(19) United States
(12) Patent Application Publication
(10) Pub. No.: US 2024/0254632 A1
(43) Pub. Date: Aug. 1, 2024

(54) Collection of Hydrogen Gas (H2) Extracted from Hydrophilic Salt in Water Source by Electrolysis

(71) Applicant: Michael Eugene Thomas, Pocomoke City, MD (US)

(72) Inventor: Michael Eugene Thomas, Pocomoke City, MD (US)

(21) Appl. No.: 17/803,946

(22) Filed: Feb. 1, 2023

(51) Int. Cl. C25B 1/04; C25B 9/65; C25B 15/08

(52) U.S. Cl. CPC C25B 1/04; C25B 9/65; C25B 15/087

(57) ABSTRACT

A hydrophilic salt in water feedstock will be used to produce hydrogen gas (H₂) from electrolyzed hydrophilic salt catalyst in water. The saltwater feedstock would be electrolyzed as shown with concentration of hydrogen gas in the saltwater 2H2O+NACL+energy=2H2+O2+NACL and that hydrogen gas can be collected by an unique inductive coil in an enclosed chamber included in the production, extraction, and collection of hydrogen gas (H₂) from the dissociated saltwater solution that will be used in today's fuel cell technologies, as a hydrogen fuel additive to hydrocarbon fuels, combustion engines, as well as, other technologies. The proposed process is to be duplicated and utilized in a unique scientifically engineered electrolyzed hydrophilic saltwater device for extraction and collection of a hydrogen gas (H₂) production and use.

### CROSS-REFERENCES TO RELATED APPLICATION

There are no patent search results teaching the art.

### BACKGROUND OF THE INVENTION

The number one priority of the World is energy independence and security through innovative technologies that create clean jobs, clean energy, and economic opportunity for growth. The invention prototype has a unique, innovative, proprietary solution to this problem by producing hydrogen (H₂) thru electrolysis from salt in water and collecting the extracted hydrogen gas. As you know, ever-increasing population growth and global industrialization continue to create a huge demand for energy. Specifically, today's drilling for fossil fuels is unsustainable and pollutive sources of energy. The invention prototype proposes production of scientifically engineered hydrogen gas (H₂) for a viable solution in sustainable nearly emissions-free energy. The largest current demand for fuel includes methods of producing substantial quantities of hydrocarbon fuels which are becoming destructive to the environment, cost prohibitive and unstable drilling, localized billion-dollar refineries, radical market price swings, and must be transported to the location for use to meet customer demand (Keystone Pipeline). To this end, the prototype has proven over 6 years to collect extracted hydrogen from salt catalyst in water, 2H2O+CATALYST+energy=2H2+O2+CATALYST, where the hydrogen gas (H₂) can be used satisfying hydrogen engine combustion, a hydrocarbon fuel additive, and evolving PEM (Proton exchange membrane also known as polymer electrolyte membrane) fuel cell demand worldwide. The Department of Energy's molecular hydrogen gas production cost target goal of $4.00 a Kg will be more costly than the $0.30 Kg targeted by this invention. But there is no worldwide technology for safe, efficient collection of hydrogen in-situ from electrolyzed saltwater. Using the cost numbers of $0.00 for free saltwater feed stock with $50 hr. electricity cost will lead to hydrogen (H₂) production available for sale at $ 0.30 Kg price. The prototype hydrogen production of 1440 liters/hour is enough to power a 2 kilowatt fuel cell continuously. The patent application is pioneering a successful 6-year prototype operation of hydrogen (H₂) gas extraction from electrolyzed salt in water and collected by a novel inductive atomic mass filter. Seawater and Saltwater are a worldwide FREE feedstock materials unregulated, taxed or controlled by any country in the world. Expectations are to make continuing discoveries in hydrogen molecule production, extraction, and collection physics that can work towards solving better energy chemistry allowing for improved environmental conditions all over the world as one of the goals.

The benefit of this unique prototype to the world is future energy independence, a stable energy supply, protection of the world's environment, political stability, and economic security. All know scientific atomic mass filter technologies of the world are constructed as quadrupoles for ion trapping of atomic species. The prototype has a world's first inductive coil immersed in electrolyzed saltwater for operation of a polarized insulated wire wound inductor coil using negative static voltage induction EMF (electric and magnetic fields) and a transverse audio frequency generator signal for a hydrogen gas collection. Expectations to further develop a methodology that can deliver substantial quantities of low-cost renewable hydrogen (H₂) gas from clean saltwater, brine, or brackish water. This will greatly add to the strength and financial stability of the world and decrease dependence on hydrocarbon drilling, mining, expensive geopolitical refineries, toxic waste, and environmental disasters in the world's thirst for hydrocarbons. The future of the world will benefit because hydrogen gas, as an energy resource, exists in abundance in H₂O and is an underutilized feedstock resource by the world. Verification and certification using a hydrogen production prototype has demonstrated successful generation of hydrogen gas for 6 years successfully. The prototype has been built and tested, the invention envisions a time when scientifically engineered hydrogen (H₂) gas fuel will help to reduce greenhouse gases, increase higher quality energy generation and controlling energy cost forever using an infinite renewable energy saltwater feedstock source. Our scientific dissociation technology is focused on actual low cost localized in-situ onsite production of hydrogen (H₂) gas energy that can compete but not replace other worldwide energy sources in the marketplace, which will lead to tangible, non-disruptive, and cleaner renewable hydrogen (H₂) gas energy products. The process of producing hydrogen (H₂) gas from electrolyzed saltwater by a successful prototype has proven over 6 years a safe and cost-effective process for high volume hydrogen extraction and collection where the construction of other production systems can be manufactured by amateur to professional persons.

### Object of the Invention

It is the object of the present invention prototype to provide unique improvements in all the above-mentioned areas and to produce, extract, and collect hydrogen gas (H₂) from an electrolyzed saltwater feed stock that uniquely outperforms all known hydrogen gas (H₂) technologies in the state of the art as it now exists.

### BRIEF SUMMARY OF THE INVENTION

The invention prototype is a standalone in-situ “disruptive innovation” for hydrogen gas production meeting the United Nation's mission of ensuring political security, environmental protection, and prosperity for all the World's populations by allowing countries to slowly remove themselves from chaotic geo-political issues related to foreign oil importation. Our unique patent application will allow us to produce hydrogen gas (H₂) inexpensively, extract hydrogen from electrolyzed saltwater, and uniquely collect hydrogen efficiently, and in high volumes from electrolyzed saltwater. Hydrogen gas (H₂) production capabilities can provide unlimited renewable hydrogen energy helping to preserve the World's populations and environment. Our technology will create a conduit for a new energy paradigm held by, produced by, used by, and controlled by independent Countries of the World.

### BRIEF DESCRIPTION OF THE SEVERAL VIEWS OF THE DRAWINGS

The accompanying black and white copyrighted photographs and diagram schematic in FIGS. 1, 2, 3, 4 which are incorporated in and form a part of the specification, illustrate the embodiment of the invention prototype and, together with the description, explain the principles of the invention prototype. In the photographs:

FIG. 1 is an overall schematic diagram of the invention prototype using 12 volt power supplies but any 12 volt power source could be substituted, i.e., solar panels, batteries, wind generator, or electric generator;

FIG. 2 is an overall component layout with drawing diagram of an exemplary hydrogen gas (H₂) production system that will use electrolyzed saltwater feedstock in accordance with the present invention;

FIG. 3 is an overall working hydrogen production system on a tabletop layout format;

FIG. 4 is an overall working hydrogen production system on a tabletop layout format with a functioning hydrogen proton exchange membrane (PEM) fuel cell.

### DETAILED DESCRIPTION OF THE INVENTION

Only a few presently preferred exemplary embodiments have been discussed in schematic detail below. Those of ordinary skill in the art will certainly realize that many modifications are possible without departing from the scope and spirit of the present invention as defined in the following.

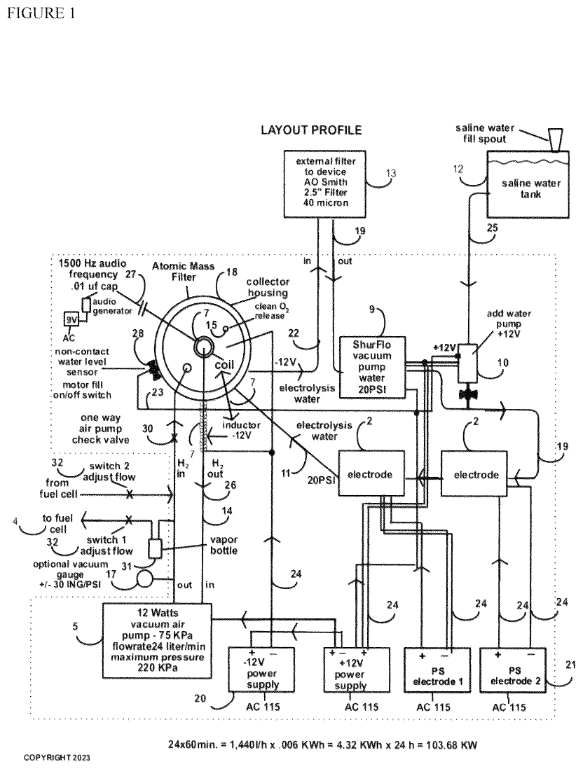

FIG. 1 schematic shows schematic of diagram of the prototype configuration, components, and connectivity.

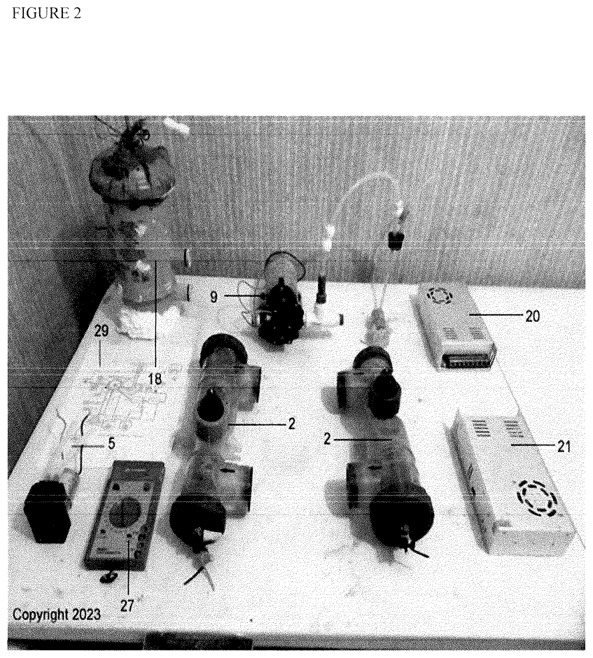

FIG. 2 is an overall component parts needed for a presently preferred prototype of a hydrogen gas (H₂) production system with a schematic drawing in FIG. 1 showing system prototype design on a 2 ft. by 4 ft. flat surface.

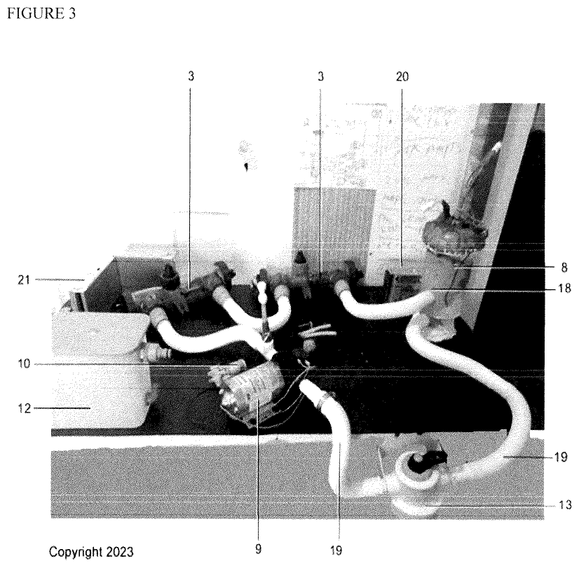

FIG. 3 is a 6 year old 2 ft. by 4 ft. flat surface working prototype device for hydrogen electrolysis of saltwater 11, extraction of hydrogen molecules 26 in the saltwater 18, and collection of suspended hydrogen 26 in the atomic mass filter (AMF) 18 by negative voltage 24 on inductive field coil 7 and audio frequency 27 output on the inductor coil 7 for the collection of hydrogen gas (+H₂) 26 in the closed loop electrolyzed saltwater piping system flow 22, 19, 11 in accordance with the present invention. Necessary components for the prototype device to function include +12 volt power supplies 21, −12 volt power supply 20, hydrogen vacuum pumps 5, electrolyzer electrodes 2, hydrogen (+H₂) 26 AMF collection tank 18, water pump 9, vacuum low water fill pump 10, saltwater feedstock 25, 19. Dissociation of electrolyzed saltwater 19 by electrodes 2 for electrolysis reaction of saltwater 2H2O+NACL+energy=2H2+O2+NACL containing hydrogen (+H₂) 12, saltwater filter 13, electrolyzed saltwater 11 in collection tank 18, returning saltwater 22 to water filter housing 13 and water feedstock 19 back to electrodes 2, +12 volt power supplies 21 for system motors and pumps 21, negative −12 volt 20 for induction field coil 7 of AMF 18, copper electrical wiring 24, hydrogen gas (+H₂) 26 in the process. When electrolyzed saltwater 19, 11, 22 is pumped 9 into the electrodes 2, water level is continually monitored by non-contact sensor 28 and add water pump 10 from the saltwater refill tank 12 keeps water line 19, 11, 22 filled with saltwater. Water sensor 28 and control line 23 for motor 10 to turn off and on to keep water lines 19, 11, 22 filled with saltwater 12. The output 11 of electrode 2 is electrolyzed (dissociated) saltwater 11 and input to AMF hydrogen collection tank 18. The hydrogen collection tank 18 with its −12 volts 24 on the inductor coil 7 along with the audio generator frequency 27 are used to collect the positively charged hydrogen (+H₂) 26 molecules at top of the AMF collection tank 18. The hydrogen induction coil 7 with its −12 volts 24 repels negative charged gases like (O₂) 15.

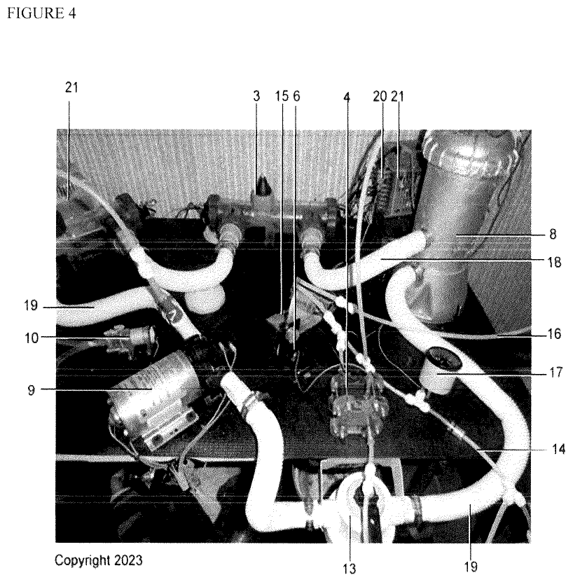

FIG. 4 is a 6-year-old 2 ft. by 4 ft. flat surface working prototype device for hydrogen electrolysis of saltwater 11 with a fuel cell 4 included. Fuel cell 4 receives the (+H2) output 26 from the AMF 18 by way of the vacuum tube 14 to input port of vacuum pumps 5 then output port of vacuum pump 5 should be balanced around 0.00 inHg/PSI using vacuum gauge 17 to PEM fuel cell 4. In line switch flow switches 32 are used to control (+H₂) flow in and out of AMF. Hydrogen (+H₂) molecules 26 combine with O₂ 15 at the fuel cell 4 with atmospheric O₂ 15 with help of the fan 6. Any exhaust H₂ gases 26 from the fuel cell 4 as well as moisture are output to the moisture vapor collection bottle 31 back to the AMF 18. The one-way air pump check valve 30 controls direction H₂ flow to AMF from output port of vacuum pump 5 a closed loop system with the input port of the AMF Chamber 18. Output fuel cell port 4 returns unused hydrogen gas 26 to AMF chamber 18 by output return port of vacuum pump 5. The saltwater refill 12 is continually added by pump 10 as needed and added to the re-circulated water pump 9 into the electrodes 2 for continued dissociation and electrolysis of water 11 back to collection tank 18 for hydrogen (+H₂) 26 continued non-stop hydrogen in-situ (+H2) 26 production and collection 18. Exhaust hydrogen (+H₂) 26 and water vapor bottle 17 from fuel cell 4 return (+H2) 26 to AMF collection tank 18. The hydrogen (+H2) 26 production and collection 18 process of the prototype can be continuously repeated non-stop.

1. What I claim as my prototype for dissociated electrolyzed hydrophilic salt in water using a negative voltage induction coil with an audio generator in an enclosed chamber for hydrogen gas (H₂) extraction and collection by:
a system to produce hydrogen gas (H₂) from electrolyzed hydrophilic salt catalyst in water of an enclosed collection chamber,
a method for collecting hydrogen gas from a electrolyzed saltwater solution by a negative voltage inductance coil in an enclosed chamber,
a self-contained chamber, sealed, transportable, autonomous, in-situ device for saltwater feedstock, hydrogen gas (H₂) production, extraction of hydrogen gas, and collection of hydrogen gas from an enclosed chamber of electrolyzed saltwater to hydrogen gas interface returning the electrolyzed saltwater feedstock from the collection chamber back to the saltwater electrolyzer electrodes, and an atomic species of hydrogen gas (H₂) for energy use to a receiving fuel cell, combustion, fuel additive, or other custom H₂ gas power utilization technologies.

2. The hydrogen gas (H₂) production process of claim 1, wherein said electrolyzing of hydrophilic saltwater feedstock by electrodes and the collection of H₂ gas by an enclosed hydrogen gas chamber with the inductive collection coil.

3. The electrolyzed saltwater for hydrogen gas (H₂) production of claim 1, wherein said hydrophilic salt in water feedstock, enclosed loop hydrogen gas piping, enclosed loop water pump system, closed loop vacuum pump, enclosed hydrogen gas chamber, power supplies, audio generator, enclosed loop electrolyzed saltwater piping connections, dissociated hydrogen gas in electrolyzed saltwater, and input power are integrated into common in-situ processing equipment system.
